(19) United States
(12) Patent Application Publication
(10) Pub. No.: US 2007/0207779 A1
(43) Pub. Date: Sep. 6, 2007

(54) Method for confirming message in mobile terminal

(75) Inventor: Youn-Taek Oh, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/705,568

(22) Filed: Feb. 12, 2007

(30) Foreign Application Priority Data
Feb. 17, 2006 (KR) 10-2006-0015559

(51) Int. Cl. H04Q 7/22

(52) U.S. Cl. 455/412.2

(57) ABSTRACT

A method for confirming a message in a mobile terminal includes selecting one of reception notification messages received from a server and stored in a memory, confirming a reception date of a multi media (multi message) corresponding to the selected reception notification message, and, displaying a notification message reporting an absence of the multi message from the server, when it is determined that a predetermined period has passed from the confirmed reception date of the multi message.

### PRIORITY

This application claims priority to an application entitled “Method For Confirming Message In Mobile Terminal” filed in the Korean Intellectual Property Office on Feb. 17, 2006 and assigned Serial No. 2006-15559, the contents of which are incorporated herein by reference.

### BACKGROUND OF THE INVENTION

1. Field of the Invention

The present invention relates to a mobile terminal, and more particularly to a method for confirming a message in a mobile terminal.

2. Description of the Related Art

Mobile terminals typically include multimedia functions including functions for viewing and photographing of various images/objects and transmission/reception of images and video, in addition to a simple communication function and a transmission/reception function of a text message.

Typically, mobile terminals include a function for transmitting a message with a limited capacity input from a user based on a transmission/reception function of a short message. Further, mobile terminals can transmit/receive a multimedia message (“multi message”) including video, audio and image data according to the multimedia function as described above.

In the case of a multi message, when a transmitting terminal transmits a text message including an attached file such as an image file or a video file, a server transmits a reception notification message, which reports the reception of the multimedia message, to a receiving terminal. Then, the receiving terminal accesses a server which is storing the multi message.

The receiving terminal can download the multi message and confirm the downloaded multi message. Herein, since the multi message is not directly transmitted to a user terminal and is separately stored in a database of the server, the terminal cannot confirm the multi message before it accesses the server. If a predetermined time passes after the server receives the multi message destined for the receiving terminal, the multi message stored in the server may be deleted. However, a user would have no way to recognize that the multi message has been deleted. On account of this, the user must periodically access the server in order to check if the multi message exists in the server. However, when the receiving terminal accesses the server, a service charge for a wireless connection is imposed on a user. Further, it takes time to access the server and then confirm the existence or absence of the multi message, a user must unnecessarily spend time and pay the service charge regardless of whether a multi message destined for the receiving terminal exists in the server.

### SUMMARY OF THE INVENTION

Accordingly, the present invention has been made to solve the above-mentioned problems occurring in the prior art, and it is an object of the present invention to provide a method by which a mobile terminal can quickly and accurately confirm message reception.

In accordance with one aspect of the present invention, there is provided a method for confirming a message in a mobile terminal, the method including selecting one of reception notification messages received from a server and stored in a memory; confirming a reception date of a multi message corresponding to the selected reception notification message, and when a predetermined period has passed from the confirmed reception date of the multi message, displaying a notification message reporting an absence of the multi message from the server.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the construction of a system for confirming message reception according to the present invention;

FIG. 2 is a block diagram illustrating the detailed construction of a mobile terminal according to the present invention;

FIG. 3 is a flow diagram illustrating a message transmission/reception operation according to the present invention; and

FIG. 4 is a flow diagram illustrating a message confirmation operation according to the present invention.

### DETAILED DESCRIPTION OF THE PREFERRED EMBODIMENT

A preferred embodiment of the present invention will be described in detail herein below with reference to the accompanying drawings. In the below description, many particular items, such as detailed elements, are shown, but these are provided for the general understanding of the present invention, it will be understood by those skilled in the art that such particular items can be modified without departing from the scope and spirit of the present invention.

According to the present invention, a transmitted/received message will be described taking an example of a multimedia message (i.e., a “multi message”) including images and video. However, the present invention can also be applied to a general transmission/reception message as well as a multi message.

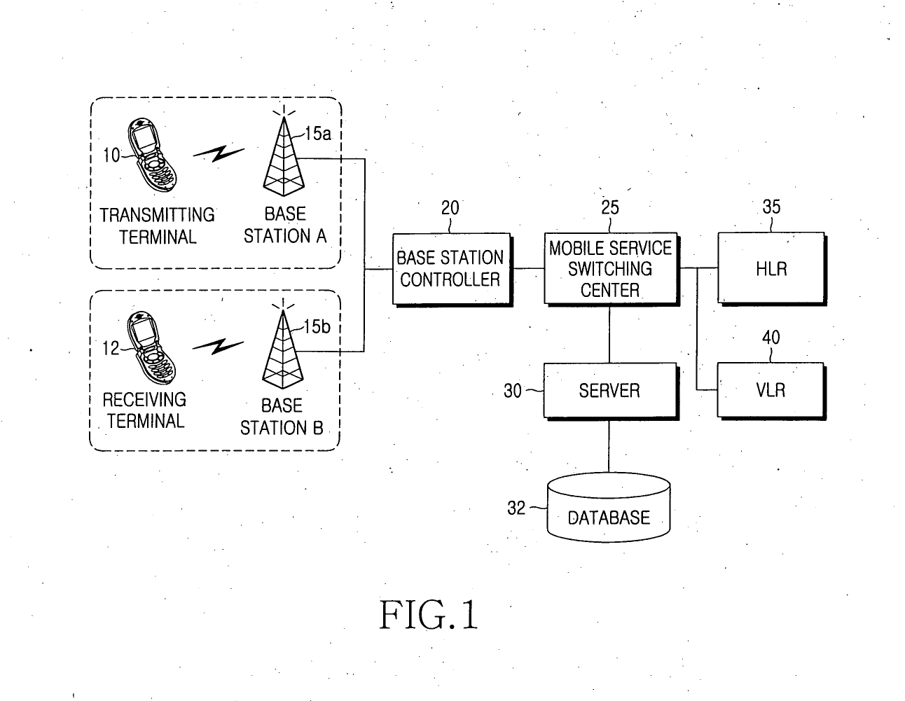

FIG. 1 is a block diagram illustrating the construction of a system for confirming message reception according to the present invention. Referring to FIG. 1, a mobile communication system generally includes base stations 15a and 15b for managing fixed areas, a base station controller 20 for managing and controlling a plurality of base stations, a mobile service switching center 25, a Home Location Register (HLR) 35, a Visitor Location Register (VLR) 40, etc. The HLR 35 is an element for registering location information of terminals and user profiles therein. The VLR 40 is an element for registering temporary user information in order to manage requests from users out of the covered area. The current locations of mobile terminals 10 and 12 are understood by the base stations 15a and 15b, and reported to the mobile service switching center 25 through the base station controller 20, and the HLR 35 and the VLR 40 are used for recording information about movement of users.

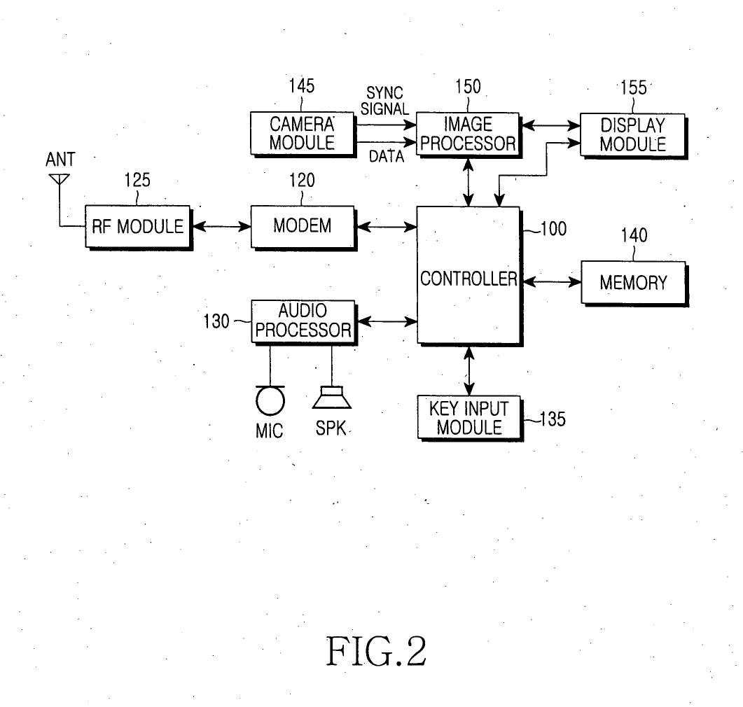

A mobile communication system according to the present invention includes a message-transmitting terminal 10 (transmitting terminal) for transmitting the multi message, a message-receiving terminal 12 (receiving terminal) for receiving the multi message transmitted from the transmitting terminal 10, and a server 30 for accessing the transmitting terminal 10 and the receiving terminal 12 through corresponding base stations. The receiving terminal 12 receives a reception notification message from the server 30, wherein the reception notification message reports that a multi message has been received from the transmitting terminal 10. Further, the receiving terminal 12 stores the reception notification message in a memory (not shown). When one of a multi messages is selected by a user, the receiving terminal 12 confirms the reception dates of the selected reception notification message and the multi message. According to confirmation results, the receiving terminal 12 accesses the server 30 storing the received multi messages and downloads the multi message. The function of the receiving terminal 12 will be described in detail with reference to FIG. 2 illustrating the detailed construction of the terminal according to the present invention.

A database 32 is connected to the server 30, and stores both the multi message received from the transmitting terminal 10 and attached files included in the multi message. The server 30 transmits a reception notification message to a terminal (e.g., receiving terminal 12) which will receive a message sent from the transmitting terminal 10, wherein the reception notification message indicates message reception. The server 30 can transmit the reception notification message including header information having the reception date of the multi message to the receiving terminal 12. After receiving the reception notification message, the receiving terminal 12 displays the reception notification message together with the reception date and/or the scheduled deletion date of the multi message. When access-trial signals to the server 30 are received from the receiving terminal 12 having received the reception notification message, the server 30 uploads both messages stored in the database 32 connected to the server 30 and the attached files included the message to the receiving terminal 12.

FIG. 2 is a block diagram illustrating the detailed construction of a mobile terminal according to the present invention. The mobile terminal illustrated in FIG. 2 is constructed similarly and includes similar functions to the receiving terminal 12 and the transmitting terminal 10 which are illustrated in FIG. 1

Hereinafter, the functions of respective terminals will be described. Referring to FIG. 2, a controller 100 controls general operation of mobile terminals 10 and 12. The controller 100 of the transmitting terminal 10 according to the present invention controls messages input from a user or attached files within the messages to be transmitted to the corresponding receiving terminal 12. When a predetermined message reporting that the messages have been transmitted to the receiving terminal 12 is received from the server 30, the controller 100 controls the predetermined message to be displayed on a display module 155 or to be stored in a memory 140.

The controller 100 of the receiving terminal 12 according to the present invention receives reception notification messages reporting the reception of a multi message from the server 30 and stores the received messages in the memory 140. When one of the stored reception notification messages is selected by a user, the controller 100 determines the reception date of the reception notification message and the reception date of the multi message corresponding to the reception notification message. According to the confirmation results of the determination of the reception date, the controller 100 may generate messages, which report that the multi messages and the attached files included in the multi messages exist or do not exist in the server 30, to be displayed on the display module 155, and executes wireless access to the server 30.

A modem 120 includes a transmitter for coding and modulating transmitted signals, a receiver for decoding and demodulating received signals, etc.

An RF module 125 performs communication operations of the mobile terminal 10/12. A wireless processor 135 includes an RF (Radio Frequency) transmitter for up-converting and amplifying frequencies of transmitted signals, an RF receiver for low noise-amplifying received signals and down-converting frequencies of the received signals, etc. The RF module 125 according to the present invention transmits a multi message input from a user, receives a reception notification message according to the reception of the multi messages from the server 30, and allows the terminal to access the server 30 and to download the multi message.

The audio processor 130 may include a CODEC (CODER/DECODER) classified as a data CODEC for processing packet data, etc., and an audio codec for processing audio signals including voice, etc. The audio processor 130 converts digital audio signals received from the modem 120 into analog signals through the audio codec for reproduction via a speaker (SPK), or converts analog audio signals generated and transmitted from a microphone (MIC) into digital audio signals through the audio codec, and transmits the converted digital audio signals to the modem 120. The audio processor 130 according to the present invention outputs the alarm sound based on the transmission/reception of a multi message. In addition, the audio processor 130 outputs audio signals according to audio files when playing various audio files included in the multi message.

A key input module 135 includes keys for inputting numeral and/or character information, and function keys for setting various functions. The key input module 135 is used for receiving input of various messages from a user according to the present invention. Also, the key input module 135 is used for receiving input of signals for accessing the server 30.

A memory 140 may include a program memory and a data memory. The program memory may store programs for controlling a general operation of the mobile terminal. The memory 140 stores the reception notification message reporting the reception of the multi message according to the present invention.

A camera module 145 includes a camera sensor for photographing image data and converting photographed optical signals into electrical signals, and a signal processor for converting analog image signals photographed by the camera sensor into digital data. Herein, it is assumed that the camera Sensor includes a CCD (Charge-Coupled Device) sensor, and the signal processor may be realized by a Digital Signal Processor (DSP). In addition, the camera sensor may be integrated with the signal processor, or may also be constructed separately from the signal processor.

An image processor 150 generates screen data for displaying image signals output from the camera module 145. The image processor 150 processes image signals, which are output from the camera module 145, by frames and outputs frame image data according to the characteristic and/or sizes of the display module 155. The image processor 150 includes an image codec, and compresses the frame image data, which is displayed on the display module 155, by means of a predetermined scheme, and restores the compressed frame image data into original frame image data. Herein, the image codec may include a JPEG (Joint Photographic Experts Group) codec, a MPEG4 (Motion Picture Experts Group-4) codec, a Wavelet codec, etc. It is assumed that the image processor 150 has an On Screen Display (OSD) function, and the image processor 150 can output on-screen display data according to displayed screen sizes under the control of the controller 100.

The display module 155 displays both the image signals output from the image processor 150 on the screen and user data output from the controller 100. Herein, the display module 155 includes a Liquid Crystal Display (LCD). In which a case, the display module 155 may include a LCD controller, a memory capable of storing image data, a LCD display element, etc. Herein, if the LCD employs a touch-screen type display, the display module 155 may operate as an input module.

The display module 155 according to the present invention displays a reception notification message received from the server 30. Further, the display module 155 displays the reception date and scheduled deletion date of the multi message, or a message for reporting the absence of the multi message in the server 30 due to deletion of the multi message. When the deletion date of the multi message stored in the server 30 is reached, the display module 155 can display a message which reports the deletion of the multi message stored in the server 30.

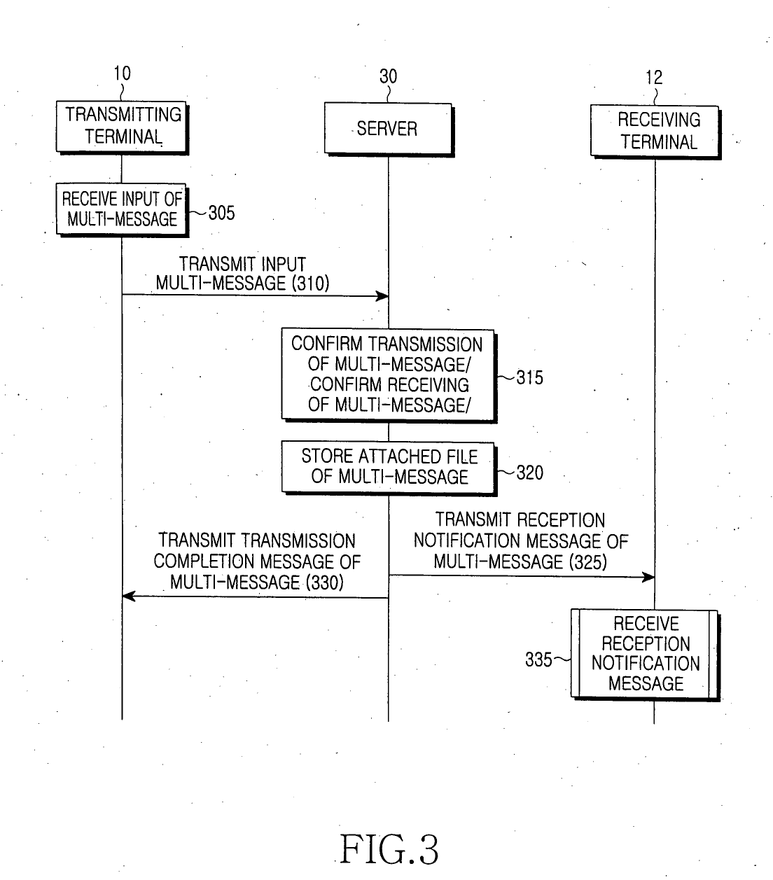

FIG. 3 shows a flow diagram illustrating a message transmission/reception operation according to the present invention. Referring to FIG. 3, the transmitting terminal 10 receives a multi message from a user in step 305. The multi message includes text and attached files. In step 310, the transmitting terminal 10 receives information of the receiving terminal 12, which will receive the multi message, from the user and transmits the information through the RF module 125. In step 315, after preferentially receiving the transmitted multi message, the server 30 confirms both information of the transmitting terminal 10 having transmitted the multi message and information of the receiving terminal 12. In step 320, the server 30 stores the multi message transmitted from the transmitting terminal 10 in the database 32. The information in the database 32 may include attached files included in the multi message, and the text and attached files of the multi message. Although other types of files may be stored, for the sake of clarity, the present invention describes a case of storing only the attached file.

In step 325, after storing the attached files of the multi message, the server 30 transmits a reception notification message to the receiving terminal 12, the reception notification message provide an indication of the reception of the multi message from the transmitting terminal 10. The reception notification message may include the reception date of the multi message, a period during which the multi message is stored in the server 30, and the scheduled deletion date of the multi message. When the server 30 confirms that the reception notification message has been transmitted to the receiving terminal 12, the server 30 transmits a transmission completion message to the transmitting terminal 10 in step 330, the transmission completion message indicates that the multi message has been successfully transmitted. Accordingly, in step 335, the receiving terminal 12 receives the reception notification message from the server 30, the reception notification message indicates that the multi message has been received.

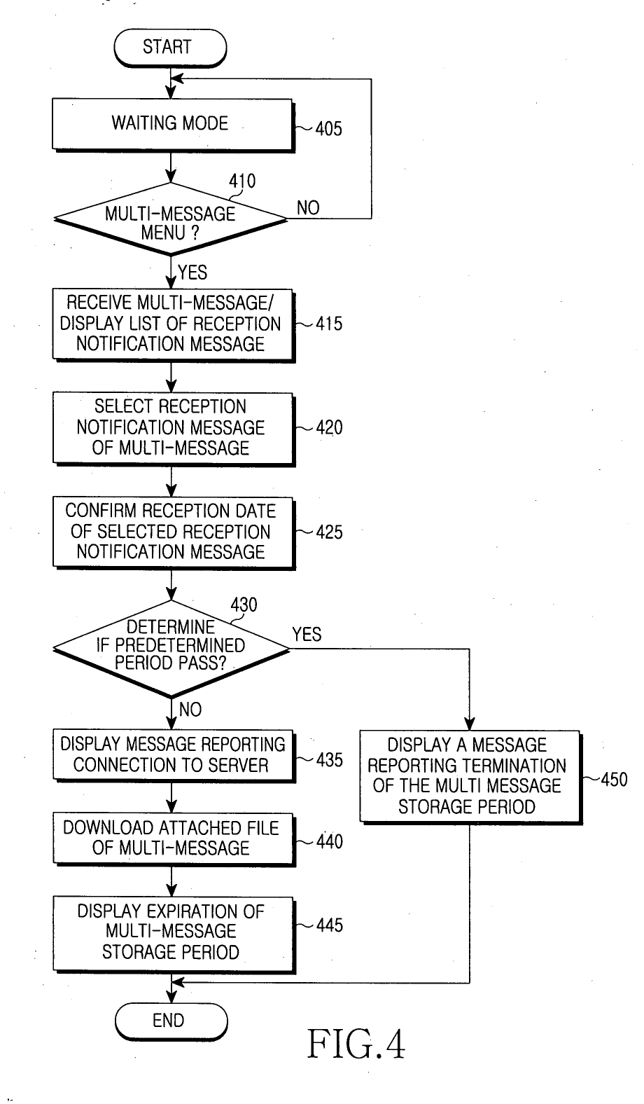

A process in which the receiving terminal 12 receives the multi message will now be described in detail with reference to FIG. 4.

FIG. 4 is a flow diagram illustrating a message confirmation operation according to the present invention. In step 405, the controller 100 operates in a waiting mode. In step 410, the controller 100 determines whether a multi message menu command has been entered. When receiving input of the multi message menu according to the results of the determination of step 410, the controller 100 displays a list of the reception notification messages received from the server 30 and stored in the memory 140 on the display module 155, in the step 415. In the step 420, one of the reception notification messages displayed on the display module 155 is selected. In step 425, the controller 100 determines the reception date of the selected reception notification message. Herein, since the reception date of the reception notification message may be different from that of the multi message received from the transmitting terminal 10, the controller 100 can confirm both the reception date of the reception notification message and the reception date of the multi message included in the header information of the reception notification message.

According to the present invention, for the sake of clarity, only the reception date of the multi message will be described.

In step 430, the controller 100 determines whether a predetermined period has passed according to the results of the determination of the reception date. The predetermined period is a period during which the multi message is stored in the database 32 after the multi message is received. When the period has passed, the multi message and attached files stored in the database 32 may be automatically deleted. When the controller 100 determines that the predetermined period has not passed in the step 430, the controller 100 displays a message reporting a connection to the server in order to download multi message in step 435. In step 440, the controller 100 downloads the multi message and attached files stored in the database 32 connected to the server 30 and stores the downloaded the multi message and attached files in the memory 140.

However, when it is determined that the predetermined period has passed, in step 430, the controller 100 displays a message reporting an absence (or deletion) of the multi message in the database 32 due to the termination of the multi message storage period in the step 445. The displayed message may include the deletion date, the reception date, and deletion information.

In the message reception confirmation operation according to present invention, the server 30 confirms that the multi message has been received from the transmitting terminal 10, and transmits a reception notification message reporting that the multi message has been received in the corresponding receiving terminal 12. After receiving the reception notification message, the receiving terminal 12 stores the received reception notification message in the memory 140. When signals requesting confirmation of the multi message are detected, the receiving terminal 12 confirms both the reception date of the reception notification message stored in the memory 140 and the reception date of the multi message included in the header information of the reception notification message. According to whether the predetermined period has passed from the reception date, the receiving terminal 12 displays a message reporting the deletion of the multi message stored in the database 32 connected to the server 30, or accesses the server 30 to download the multi message.

Although not shown in the accompanying drawings, according to an the present invention, the receiving terminal 12 determine whether a predetermined period has passed according to the reception date of a reception notification message stored in the memory 140 thereof while the receiving terminal 12 is in a waiting mode. Accordingly, when the scheduled deletion date of the multi message is reached according to the passage of the predetermined period, the receiving terminal 12 can display a notification message.

In the present invention as described above, when a multi message is received, it is possible to confirm the state of a multi message according to whether a predetermined time has passed from a reception date of the multi message even without accessing a server. Consequently, it is possible to enhance a user's convenience while reducing communication time and associated cost.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A method for confirming a message in a mobile terminal, the method comprising the steps of:
selecting one of reception notification messages received from a server and stored in a memory;
confirming a reception date of a multimedia message (multi message) corresponding to the selected reception notification message; and
when a predetermined period has passed from the confirmed reception date of the multi message, displaying a notification message the multi message has been deleted from the server.

2. The method as claimed in claim 1, wherein the multi message includes one of a text message and text message including an attached file.

3. The method as claimed in claim 1, wherein the reception notification message received from the server includes at least one of the reception date of the multi message, a period during which the multi message will be stored in the server, and a scheduled deletion date of the multi message.

4. The method as claimed in claim 1, further comprising cache of the reception dates, when the reception date of the multi message is different from a date of the reception notification message.

5. The method as claimed in claim 1, further comprising display deletion information including a deletion date of the multi message, when the notification message about the deletion of the multi message from the server is displayed.

6. The method as claimed in claim 1, further comprising displaying a message about expiration of a storing period of the multi message, when a predetermined period of an unconfirmed multi message among the reception notification messages has passed.
